(19) United States
(12) Patent Application Publication
(10) Pub. No.: US 2025/0063214 A1
(43) Pub. Date: Feb. 20, 2025

(54) METHOD AND APPARATUS FOR DETERMINING LIVE STREAMING DELAY, COMPUTER DEVICE, AND STORAGE MEDIUM

(71) Applicant: Beijing Zitiao Network Technology Co., Ltd., Beijing (CN)

(72) Inventor: Donghui ZHANG, Beijing (CN)

(21) Appl. No.: 18/807,601

(22) Filed: Aug. 16, 2024

(30) Foreign Application Priority Data
Aug. 17, 2023 (CN) 202311040509.4

(51) Int. Cl. H04N 21/2187; H04N 21/43; H04N 21/8547

(52) U.S. Cl. CPC H04N 21/2187; H04N 21/4305; H04N 21/8547

(57) ABSTRACT

The present disclosure relates to the field of computer technology, and discloses a method and apparatus for determining a live streaming delay, a computer device, and a storage medium. The method provided by the present disclosure includes: sending a first clock synchronization request to a first server end node to obtain a first calibrated time difference, where the first server end node is used to process live streaming data; calibrating local time based on the first calibrated time difference to obtain calibrated time; obtaining a live streaming bitstream generated by a peer end from the first server end node to obtain a timestamp of the live streaming bitstream and a local current timestamp; and determining a live streaming delay based on the current timestamp and the timestamp of the live streaming bitstream.

### CROSS-REFERENCE TO RELATED APPLICATION(S)

This application claims priority to Chinese Application No. 202311040509.4 filed Aug. 17, 2023, the disclosure of which is incorporated herein by reference in its entity.

### FIELD

The present disclosure relates to the field of computer technology, and specifically relates to a method and apparatus for determining a live streaming delay, a computer device, and a storage medium.

### BACKGROUND

Live video streaming mainly involves processes such as acquisition, preprocessing, encoding, transmission, server transcoding, and decoding. The end-to-end delay in live streaming greatly affects the interactive experience between an audience and a streamer. Therefore, it is necessary to accurately determine the delay, so as to better optimize the live streaming delay.

### SUMMARY

In view of this, the present disclosure provides a method and apparatus for determining a live streaming delay, a computer device, and a storage medium, so as to solve the problem about determining the live streaming delay.

In a first aspect, the present disclosure provides a method for determining a live streaming delay. The method includes:
sending a first clock synchronization request to a first server end node to obtain a first calibrated time difference, where the first server end node is used to process live streaming data;
calibrating local time based on the first calibrated time difference to obtain calibrated time;
obtaining a live streaming bitstream generated by a peer end from the first server end node to obtain a timestamp of the live streaming bitstream and a local current timestamp, where the timestamp is determined after clock synchronization is performed between the peer end and a second server end node, the second server end node and the first server end node are clock-synchronized, and the live streaming bitstream is transmitted from the second server end node to the first server end node; and
determining a live streaming delay based on the current timestamp and the timestamp of the live streaming bitstream.

In a second aspect, the present disclosure provides a method for determining a live streaming delay. The method includes:
sending a second clock synchronization request to a second server end node to obtain a second calibrated time difference, where the second server end node is used to process live streaming data;
calibrating local time based on the second calibrated time difference to obtain calibrated time;
obtaining live streaming data to be sent, and a timestamp corresponding to the live streaming data to be sent;
generating a live streaming bitstream based on the timestamp corresponding to the live streaming data to be sent, as well as the live streaming data to be sent; and
sending the live streaming bitstream to the second server end node to reach a peer end, such that when the live streaming delay is determined at the peer end, the second server end node is used to transmit the live streaming bitstream to a first server end node, the first server end node is used to transmit the live streaming bitstream to the peer end, the second server end node and the first server end node are clock-synchronized, and the peer end is used to determine the live streaming delay based on time synchronized with the first server end node and the timestamp in the live streaming bitstream.

In a third aspect, the present disclosure provides an apparatus for determining a live streaming delay. The apparatus includes:
a first clock synchronization request sending module, configured to send a first clock synchronization request to a first server end node to obtain a first calibrated time difference, where the first server end node is used to process live streaming data;
a first calibration module, configured to calibrate local time based on the first calibrated time difference to obtain calibrated time;
a live streaming bitstream obtaining module, configured to obtain a live streaming bitstream generated by a peer end from the first server end node to obtain a timestamp of the live streaming bitstream and a local current timestamp, where the timestamp is determined after clock synchronization between the peer end and a second server end node, the second server end node and the first server end node are clock-synchronized, and the live streaming bitstream is transmitted from the second server end node to the first server end node; and
a live streaming delay determination module, configured to determine a live streaming delay based on the current timestamp and the timestamp of the live streaming bitstream.

In a fourth aspect, the present disclosure provides an apparatus for determining a live streaming delay. The apparatus includes:
a second clock synchronization request sending module, configured to send a second clock synchronization request to a second server end node to obtain a second calibrated time difference, where the second server end node is used to process live streaming data;
a second calibration module, configured to calibrate local time based on the second calibrated time difference to obtain calibrated time;
a live streaming data to be sent obtaining module, configured to obtain live streaming data to be sent, and a timestamp corresponding to the live streaming data to be sent;
a live streaming bitstream generation module, configured to generate a live streaming bitstream based on the timestamp corresponding to the live streaming data to be sent, as well as the live streaming data to be sent; and
a live streaming bitstream sending module, configured to send the live streaming bitstream to the second server end node to reach a peer end, such that when a live streaming delay is determined at the peer end, the second server end node is used to transmit the live streaming bitstream to a first server end node, the first server end node is used to transmit the live streaming bitstream to the peer end, the second server end node and the first server end node are clock-synchronized, and the peer end is used to determine the live streaming delay based on time synchronized with the first server end node and the timestamp in the live streaming bitstream.

In a fifth aspect, the present disclosure provides a computer device, including a memory and a processor. The memory and the processor are in mutual communication connection. The memory stores computer instructions. The processor executes the computer instructions to perform the method for determining a live streaming delay in the first aspect or any one of the corresponding implementations.

In a sixth aspect, the present disclosure provides a computer-readable storage medium, storing computer instructions. The computer instructions are used to enable a computer to perform the method for determining a live streaming delay in the first aspect or any one of the corresponding implementations.

According to the method for determining a live streaming delay provided by this embodiment of the present disclosure, the server end nodes for processing the live streaming data are used as a clock synchronization benchmark, the first server end node and the second server end node are clock-synchronized, and therefore after live streaming terminals corresponding to the first server end node and the second server end node are clock-synchronized with the corresponding server end nodes, the live streaming terminals are under the same clock coordinates, and on this basis, the determination of the live streaming delay is performed, thereby ensuring accuracy of the obtained live streaming delay; and because the above clock synchronization is performed based on the server end nodes for processing the live streaming data, there is no need to introduce an additional clock synchronization server, thereby obtaining the accurate clock delay without increasing costs.

### BRIEF DESCRIPTION OF THE DRAWINGS

In order to describe technical solutions in specific implementations of the present disclosure or the prior art more clearly, accompanying drawings required to be used in the descriptions of the specific implementations or the prior art will be simply introduced below. It is apparent that the accompanying drawings described below are some implementations of the present disclosure, and those of ordinary skill in the art can obtain other accompanying drawings according to these accompanying drawings without creative work.

FIG. 1 is a block diagram of an application scenario of a live streaming delay system according to an embodiment of the present disclosure;

FIG. 2 is a schematic flowchart of a method for determining a live streaming delay according to an embodiment of the present disclosure;

FIG. 3 is a schematic flowchart of another method for determining a live streaming delay according to an embodiment of the present disclosure;

FIG. 4 is a schematic diagram of determining a first calibrated time difference according to an embodiment of the present disclosure;

FIG. 5 is a schematic flowchart of another method for determining a live streaming delay according to an embodiment of the present disclosure;

FIG. 6 is a schematic diagram of an application scenario of a method for determining a live streaming delay according to an embodiment of the present disclosure;

FIG. 7 is a structural block diagram of an apparatus for determining a live streaming delay according to an embodiment of the present disclosure;

FIG. 8 is a structural block diagram of another apparatus for determining a live streaming delay according to an embodiment of the present disclosure; and

FIG. 9 is a schematic diagram of a hardware structure of a computer device according to an embodiment of the present disclosure.

### DETAILED DESCRIPTION OF EMBODIMENTS

In order to have a clearer understanding of the objectives, technical solutions, and advantages of embodiments of the present disclosure, the technical solutions in the embodiments of the present disclosure are clearly and completely described in conjunction with the accompanying drawings in the embodiments of the present disclosure, and it is apparent that the described embodiments are only a part rather all of embodiments of the present disclosure. Based on the embodiments of the present disclosure, all other embodiments obtained by those skilled in the art without creative work shall fall within the scope of protection of the present disclosure.

A live streaming scenario includes a streamer end and an audience end. In the related art, the overall live streaming delay is calculated by utilizing a supplemental enhancement information (SEI) frame in a video bitstream, namely, by adding a timestamp of an acquisition moment of the streamer end to the SEI frame and transmitting the timestamp along with the bitstream to the audience end. Specifically, when the streamer end pushes the stream, a current system timestamp of the streamer is recorded in the SEI information of the bitstream. When the audience pulls the stream, a terminal player parses the timestamp from the SEI information of the bitstream and subtracts the timestamp in the SEI from the current system timestamp to obtain the live streaming delay. A calculation method is: live streaming delay=current system timestamp at the audience end-timestamp in the SEI information of the video bitstream.

However, in the above method, clocks of a streamer end device and an audience end device may not be synchronized. If a device time difference between the streamer and the audience at the same moment is 3 s, a live streaming delay calculation result may be inaccurate.

In some other related art, a network time protocol (NTP) server is introduced additionally or an existing NTP server is rented. However, the method requires inputting additional costs. Therefore, in most scenarios, the live streaming delay is calculated directly without clock calibration.

Based on this, a method for determining a live streaming delay provided by an embodiment of the present disclosure integrates clock synchronization with a server end node that processes live streaming data. After the clock synchronization is performed using the existing server end node, the live streaming delay is determined. The method achieves precise calculation of the live streaming delay through the clock synchronization between the streamer end device and the audience end device.

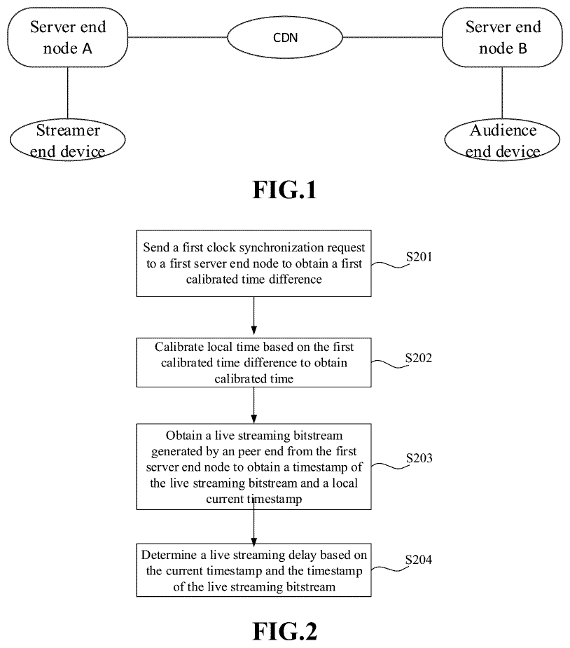

As a live streaming scenario provided by this embodiment of the present disclosure, both the streamer end device and the audience end device are referred to as live streaming devices. If the streamer end device is considered local, the peer end is the audience end device; and if the audience end device is considered local, the peer end is the streamer end device. In the live streaming process, information may be exchanged between the streamer end device and the audience end device. That is, the streamer uses the streamer end device for live streaming, and the corresponding bitstream is transmitted to the audience end device, allowing the audience to interact with the streamer through the audience end device. As shown in FIG. 1, the streamer end device is connected with a server end node A. A live streaming bitstream at the streamer end is pushed to a content delivery network (CDN) through the server end node A. The audience end device is connected with a server end node B, the live streaming bitstream is pulled from the CDN through the server end node B, and the live streaming bitstream is played on the audience end device.

According to the embodiments of the present disclosure, an embodiment of a method for determining a live streaming delay is provided. It should be noted that the steps shown in the flowchart of the accompanying drawings may be performed in a computer system such as a set of computer executable instructions. In addition, although a logical order is shown in the flowchart, the illustrated or described steps may be performed in a different order than presented here in some cases.

In this embodiment, the method for determining a live streaming delay is provided, which may be used in a computer device, such as a computer and a mobile terminal. In this embodiment, the computer device is an audience end device. FIG. 2 is a flowchart of a method for determining a live streaming delay according to an embodiment of the present disclosure. As shown in FIG. 2, the process includes the following steps:

Step S201: Send a first clock synchronization request to a first server end node to obtain a first calibrated time difference.

The first server end node is used to process live streaming data.

The first server end node is a server end node corresponding to the audience end device, and the audience end device pulls the live streaming bitstream from the first server end node for local playback. Before stream pulling, the local needs to synchronize the clock with the first server end node. Specifically, the first clock synchronization request is sent to the first server end node to synchronize the clock with the first server end node. The purpose of the clock synchronization is to calibrate local time. Therefore, after the first clock synchronization request is sent, the first calibrated time difference may be obtained by using feedback information from feedback of the first server end node. The first calibrated time difference is used to represent a time difference between the local time and the first server end node, and is utilized for calibrating the local time.

Step S202: Calibrate local time based on the first calibrated time difference to obtain calibrated time.

The local time refers to current system time of the audience end device. After being obtained, the first calibrated time difference is utilized for calibrating the local time to obtain the calibrated time. After calibration, the current system time of the audience end device is clock-synchronized with the system time of the first server end node.

The calibration method for the local time includes, but is not limited to, adding or subtracting the first calibrated time difference based on the local time, etc. The specific calibration method is related to a calculation method for the first calibrated time difference. The specific calculation method is not limited herein, which is set according to actual needs.

Step S203: Obtain a live streaming bitstream generated by a peer end from the first server end node to obtain a timestamp of the live streaming bitstream and a local current timestamp.

The timestamp is determined after clock synchronization between the peer end and a second server end node. The second server end node and the first server end node are clock-synchronized, and the live streaming bitstream is transmitted from the second server end node to the first server end node.

After the clock synchronization with the first server end node, the audience end device obtains the live streaming bitstream generated by the peer end from the first server end node. In this embodiment, the audience end device is local, and the peer end is the streamer end device. As mentioned above, the live streaming bitstream generated by the streamer end device is transmitted to the CDN through the second server end node corresponding to the streamer end device, and then transmitted to the first server end node through the CDN. The audience end device pulls the stream from the first server end node to obtain the live streaming bitstream.

The live streaming bitstream includes a timestamp of the live streaming bitstream. The timestamp is a timestamp when the live streaming bitstream is sent or generated. It should be noted that the peer end is clock-synchronized with the second server end node before live streaming, and a clock synchronization method is similar to the local clock synchronization method, which will not be repeated herein. Before a live streaming application can be used, a plurality of server end nodes are deployed, and these server end nodes need to share some logs or messages, and therefore these server end nodes are clock-synchronized. That is, the first server end node and the second server end node are clock-synchronized.

The first server end node and the second server end node are clock-synchronized, the audience end device and the first server end node are subjected to the clock synchronization, the streamer end device and the second server end node are subjected to the clock synchronization, and therefore the audience end device and the streamer end device are clock-synchronized as well.

The local current timestamp is a timestamp when the live streaming bitstream is obtained. Specifically, after the live streaming bitstream is locally pulled from the first server end node, the local current timestamp is recorded. In the absence of delay, the timestamp of the live streaming bitstream is consistent with the local current timestamp. However, due to the processing of stream pushing, network transmission, and stream pulling, delays may occur. That is, the timestamp of the live streaming bitstream is not consistent with the local current timestamp.

Step S204: Determine the live streaming delay based on the current timestamp and the timestamp of the live streaming bitstream.

After the clock synchronization, the local current timestamp lags behind the timestamp of the live streaming bitstream. Therefore, by utilizing the difference between the current timestamp and the timestamp of the live streaming bitstream, the live streaming delay may be determined.

In some optional implementations, after obtaining the live streaming delay, the audience end device, with user authorization, may report the live streaming delay to facilitate the server end node corresponding to the live streaming application to collect statistics on live streaming delays, such as calculating a mean value and a maximum live streaming delay of the live streaming delays. After a statistical result of the live streaming delays is obtained, the live streaming application is optimized and updated based on the statistical result to shorten the live streaming delays.

According to the method for determining a live streaming delay provided by this embodiment, the server end nodes for processing the live streaming data are used as a clock synchronization benchmark, the first server end node and the second server end node are clock-synchronized, and therefore after live streaming terminals corresponding to the first server end node and the second server end node are clock-synchronized with the corresponding server end nodes, the live streaming terminals are under the same clock coordinates, and on this basis, the determination of the live streaming delay is performed, thereby ensuring accuracy of the obtained live streaming delay; and because the above clock synchronization is performed based on the server end nodes for processing the live streaming data, there is no need to introduce an additional clock synchronization server, thereby obtaining the accurate clock delay without increasing costs.

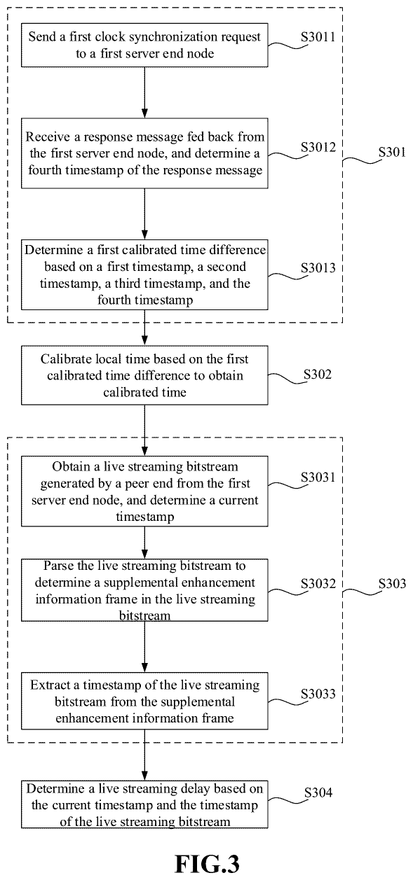

In this embodiment, the method for determining a live streaming delay is provided, which may be used in a computer device, such as a computer and a mobile terminal. FIG. 3 is a flowchart of a method for determining a live streaming delay according to an embodiment of the present disclosure. As shown in FIG. 3, the process includes the following steps:

Step S301: Send a first clock synchronization request to a first server end node to obtain a first calibrated time difference.

The first server end node is used to process live streaming data.

Specifically, step S301 includes:

Step S3011: Send the first clock synchronization request to the first server end node.

The first clock synchronization request includes a first timestamp when the clock synchronization request is sent.

The first clock synchronization request is sent to the first server end node. The format of the first clock synchronization request may be based on the format of an NTP request, or the format of an APP request, etc. The specific format of the first clock synchronization request is not limited herein, which is specifically set according to actual needs. It should be noted that sending of the first clock synchronization request may be triggered by interacting with a clock synchronization control provided on an interface of the live streaming application; or a method for automatically triggering the first clock synchronization request may be adopted, and the time for automatic trigger may be after starting the live streaming application, or before the live streaming begins, etc. The specific time is set according to actual needs.

In some optional implementations, step S3011 includes:
Step a1: Obtain a start instruction for the live streaming application so as to start the live streaming application.
Step a2: Trigger local sending of the first clock synchronization request to the first server end node after the live streaming application is started.

The user generates the start instruction through interaction with the audience end device. Correspondingly, the start instruction for the live streaming application is obtained, and the live streaming application is started by executing the start instruction. After the live streaming application is started, the sending of the first clock synchronization request is automatically triggered, that is, the local sending of the first clock synchronization request to the first server end node is triggered.

After the live streaming application is started, the clock synchronization with the first server end node is automatically triggered, thereby simplifying the processing process. Moreover, the clock synchronization is automatically achieved without user awareness, thereby improving user experience.

Step S3012: Receive a response message fed back from the first server end node, and determine a fourth timestamp of the response message.

The response message carries a second timestamp when the first clock synchronization request reaches the first server end node and a third timestamp when the first server end node sends the response message.

After the first clock synchronization request is sent to the first server end node, the first server end node feeds back the corresponding response message based on the first clock synchronization request. Specifically, the response message carries a plurality of timestamps, including the second timestamp when the first clock synchronization request reaches the first server end node and the third timestamp when the first server end node sends the response message. After receiving the first clock synchronization request, the first server end node records reception time to obtain the second timestamp; and the second server end node sends the response message, and records sending time of the response message to obtain the third timestamp. Both the second timestamp and the third timestamp are encapsulated in the response message and fed back with the response message.

When receiving the response message, the audience end device records the reception time of the response message to obtain the fourth timestamp. Therefore, the audience end device may obtain the first timestamp, the second timestamp, the third timestamp, and the fourth timestamp.

Step S3013: Determine the first calibrated time difference based on the first timestamp, the second timestamp, the third timestamp, and the fourth timestamp.

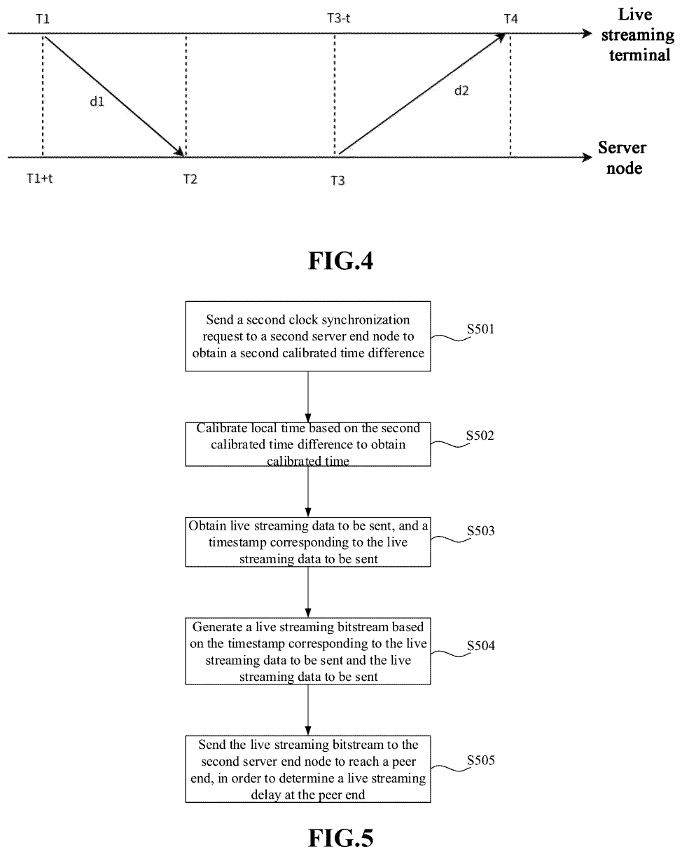

As shown in FIG. 4, a round-trip delay of the message from the audience end device to the first server end node is delay=2t, where t is a one-way delay, namely, delay=(t4−t1)−(t3−t2), where t4 is the fourth timestamp, t3 is the third timestamp, t2 is the second timestamp, and t1 is the first timestamp.

The first calibrated time difference between the audience end device and the first server end node is offset, namely:

$$\{ \begin{matrix}t 2 = t 1 + offset + \frac{delay}{2} \\ t 4 = t 3 - offset + \frac{delay}{2}\end{matrix}$$

Therefore, through the above formula, the first calibrated time difference offset is obtained:

$$offset = \frac{( t 2 - t 1 ) + ( t 3 - t 4 )}{2}$$

Step S302: Calibrate local time based on the first calibrated time difference to obtain calibrated time.

After the first calibrated time difference offset is obtained, the sum of the first calibrated time difference and the local time is determined as the calibrated time.

The calculation method for the first calibrated time difference represents a delay difference between the local and the first server end node, and therefore, adding the local time after obtaining the first calibrated time difference may yield the calibrated time.

Step S303: Obtain a live streaming bitstream generated by a peer end from the first server end node to obtain a timestamp of the live streaming bitstream and a local current timestamp.

The timestamp is determined after the clock synchronization between the peer end and the second server end node. The second server end node and the first server end node are clock-synchronized, and the live streaming bitstream is transmitted from the second server end node to the first server end node.

Specifically, step S303 includes:

Step S3031: Obtain a live streaming bitstream generated by a peer end from the first server end node, and determine a current timestamp.

The audience end device pulls the live streaming bitstream from the first server end node, and records the current timestamp when the live streaming bitstream is obtained. The current timestamp is obtained based on the calibrated time.

Step S3032: Parse the live streaming bitstream to determine a supplemental enhancement information frame in the live streaming bitstream.

The timestamp of the live streaming bitstream is written into the SEI frame. After being pulled, the live streaming bitstream is parsed to determine the SEI frame.

Step S3033: Extract a timestamp of the live streaming bitstream from the supplemental enhancement information frame.

After the SEI frame is determined, the timestamp of the live streaming bitstream is extracted from the SEI frame. The SEI frame may also include other information for other needs, which is not limited herein.

Step S304: Determine a live streaming delay based on the current timestamp and the timestamp of the live streaming bitstream.

Specifically, the live streaming delay is determined based on a difference between the current timestamp and the timestamp of the live streaming bitstream. Namely, live streaming delay=current timestamp-timestamp of the live streaming bitstream.

According to the method for determining a live streaming delay provided by this embodiment, the first calibrated time difference is determined by sending the first clock synchronization request, receiving the feedback response message, and using the respective timestamps. Because the round-trip time between the local and the first server end node is fixed, the first calibrated time difference can be rapidly and accurately determined in conjunction with a timestamp method. Because the supplemental enhancement information frame is a frame into which corresponding information is written based on demands, the supplemental enhancement information frame of the live streaming bitstream includes the timestamp generating the live streaming bitstream, thereby simplifying the timestamp transmission method. Because the live streaming delay represents the time difference between the local and the peer end, using the difference between the local current timestamp and the timestamp of the live streaming bitstream as the live streaming delay may intuitively represent the above time difference without conversion.

In this embodiment, the method for determining a live streaming delay is provided, which may be used in a computer device, such as a computer and a mobile terminal. FIG. 5 is a flowchart of a method for determining a live streaming delay according to an embodiment of the present disclosure. As shown in FIG. 5, the process includes the following steps:

Step S501: Send a second clock synchronization request to a second server end node to obtain a second calibrated time difference.

The second server end node is used to process live streaming data.

The method for obtaining the second calibrated time difference is similar to the method for obtaining the first calibrated time difference. However, the difference lies in that the second calibrated time difference is obtained after the streamer end device sends the second clock synchronization request to the second server end node, and the first calibrated time difference is obtained after the audience end device sends the first clock synchronization request to the first server end node. For the method for obtaining the second calibrated time difference, reference is made to the detailed description of the method for obtaining the first calibrated time difference above, which will not be repeated herein.

Step S502: Calibrate the local time based on the second calibrated time difference to obtain calibrated time.

Similar to the time calibration of the audience end device, after the second calibrated time difference is obtained, the local time of the streamer end device is calibrated using the second calibrated time difference to obtain the local calibrated time. The local time before calibration is the current system time of the streamer end device.

Step S503: Obtain live streaming data to be sent, and a timestamp corresponding to the live streaming data to be sent.

After the streamer end device generates the live streaming data to be sent, the timestamp of the live streaming data to be sent is obtained. As mentioned above, the timestamp may be a timestamp when the live streaming bitstream is subsequently sent, or a timestamp when the live streaming data to be sent is generated.

Step S504: Generate a live streaming bitstream based on the timestamp corresponding to the live streaming data to be sent, as well as the live streaming data to be sent.

The timestamp corresponding to the live streaming data to be sent, as well as the live streaming data to be sent are encapsulated to generate the live streaming bitstream. The timestamp corresponding to the live streaming data to be sent may be sent using a separate data frame, such as being attached to a frame header of the live streaming data, or using the SEI frame. A specific method for sending the timestamp corresponding to the live streaming data to be sent is set according to actual needs, which is not limited herein.

In some optional implementations, step S504 includes:
Step b1: Determine a supplemental enhancement information frame in the live streaming data to be sent.
Step b2: Write a timestamp corresponding to the live streaming data to be sent into the supplemental enhancement information frame to generate the live streaming bitstream.

The position of the SEI frame is determined in the live streaming data to be sent, and the timestamp corresponding to the live streaming data to be sent is written into the SEI frame to be encapsulated together with the live streaming data to be sent, thereby generating the live streaming bitstream.

Step S505: Send the live streaming bitstream to the second server end node to reach the peer end, in order to determine a live streaming delay at the peer end.

The second server end node is used to transmit the live streaming bitstream to the first server end node, and the first server end node is used to transmit the live streaming bitstream to the peer end. The second server end node and the first server end node are clock-synchronized, and the peer end is used to determine the live streaming delay based on time synchronized with the first server end node and the timestamp in the live streaming bitstream.

The live streaming bitstream is first transmitted to the second server end node, reaches the CDN, and then is transmitted to the first server end node from the CDN. The audience end device pulls the stream from the first server end node to obtain the live streaming bitstream. After the audience end device obtains the live streaming bitstream and the corresponding timestamp, for a specific method for determining the live streaming delay, reference is made to the above description, which will not be repeated herein.

According to the method for determining a live streaming delay provided by this embodiment, the server end nodes for processing the live streaming data are used as a clock synchronization benchmark, the first server end node and the second server end node are clock-synchronized, and therefore after live streaming terminals corresponding to the first server end node and the second server end node are clock-synchronized with the corresponding server end nodes, the live streaming terminals are under the same clock coordinates, and on this basis, the determination of the live streaming delay is performed, thereby ensuring accuracy of the obtained live streaming delay; and because the above clock synchronization is performed based on the server end nodes for processing the live streaming data, there is no need to introduce an additional clock synchronization server, thereby obtaining the accurate clock delay without increasing costs.

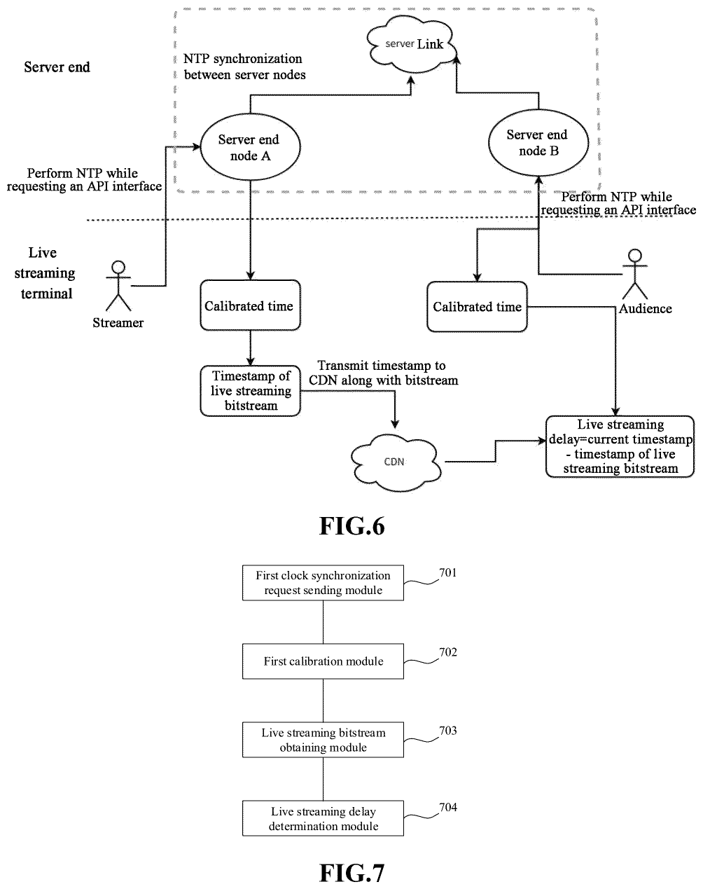

As a specific application embodiment of the embodiments of the present disclosure, as show in FIG. 6, with live streaming of the streamer end as an example, the streamer end device and the audience end device are collectively referred to as live streaming terminals. Through interaction with the live streaming application in the streamer end device, the streamer starts the live streaming application. After the live streaming application is started, clock synchronization is performed while the server end node A is requested for an application programming interface (API). The clock synchronization with the server end node A is performed so as to calibrate the time of the streamer end device, thereby obtaining the calibrated time. Before live streaming begins, the streamer end device also interacts with the server end node A so as to allocate a live streaming room number, etc. After the streamer starts the live streaming, the generated live streaming bitstream and the timestamp thereof are both pushed to the server end node A and then uploaded to the CDN via the server end node A. The audience for the live streaming starts the live streaming application through interaction with the audience end device, and in this case, the audience end device and the server end node B are clock-synchronized to calibrate the time of the audience end device, thereby obtaining the calibrated time. The audience interacts with the live streaming application to select the desired live streaming room number to enter. Correspondingly, the stream is pulled from the server end node B based on the live streaming room number, and the server end node B obtains the corresponding live streaming bitstream from the CDN based on the live streaming room number and transmits the live streaming room number to the audience end device, thereby performing playback in the audience end device. In this case, the audience end device determines the live streaming delay using the difference between the timestamp in the live streaming bitstream and the current timestamp. The audience end device may upload the live streaming delay to the server end node B, such that the server end node B analyzes the state of the live streaming delay to obtain an analysis result, thereby optimizing the live streaming application or providing a corresponding optimization suggestion.

In this embodiment, an apparatus for determining a live streaming delay is further provided. The apparatus is used to implement the above embodiments and preferred implementations, and details that have been described are not repeated. The term “module” used as below may implement combination of software and/or hardware with preset functions. Apparatuses described in the following embodiments are preferably implemented by the software, but it is possible and conceivable for implementing the apparatuses through the hardware or a combination of the software and the hardware.

This embodiment provides an apparatus for determining a live streaming delay, as shown in FIG. 7, including:
a first clock synchronization request sending module 701, configured to send a first clock synchronization request to a first server end node to obtain a first calibrated time difference, where the first server end node is used to process live streaming data;
a first calibration module 702, configured to calibrate local time based on the first calibrated time difference to obtain calibrated time; and
a live streaming bitstream obtaining module 703, configured to obtain a live streaming bitstream generated by a peer end from the first server end node to obtain a timestamp of the live streaming bitstream and a local current timestamp, where the timestamp is determined after clock synchronization between the peer end and a second server end node, the second server end node and the first server end node are clock-synchronized, and the live streaming bitstream is transmitted from the second server end node to the first server end node; and
a live streaming delay determination module 704, configured to determine a live streaming delay based on the current timestamp and the timestamp of the live streaming bitstream.

In some optional implementations, the first clock synchronization request sending module 701 includes:
a first request sending unit, configured to send a first clock synchronization request to the first server end node, where the first clock synchronization request includes a first timestamp when the clock synchronization request is sent;
a response message receiving unit, configured to receive a response message fed back by the first server end node, and determine a fourth timestamp when the response message is received, where the response message carries a second timestamp when the first clock synchronization request reaches the first server end node and a third timestamp when the first server end node sends the response message; and
a first calibrated time difference determination unit, configured to determine the first calibrated time difference based on the first timestamp, the second timestamp, the third timestamp, and the fourth timestamp.

In some optional implementations, the first request sending unit includes:
a start instruction obtaining subunit, configured to obtain a start instruction for a live streaming application so as to start the live streaming application; and
a request trigger subunit, configured to trigger local sending of the first clock synchronization request to the first server end node after the live streaming application is started.

In some optional implementations, the live streaming bitstream obtaining module 703 includes:
a live streaming bitstream obtaining unit, configured to obtain a live streaming bitstream generated by a peer end from the first server end node, and determine a current timestamp;
a live streaming bitstream parse unit, configured to parse the live streaming bitstream to determine a supplemental enhancement information frame in the live streaming bitstream; and
a timestamp extraction unit, configured to extract a timestamp of the live streaming bitstream from the supplemental enhancement information frame.

In some optional implementations, the first calibration module 702 includes:
a first calibration unit, configured to determine the sum of the first calibrated time difference and the local time as the calibrated time.

In some optional implementations, the live streaming delay determination module 704 includes:
a live streaming delay determination unit, configured to determine a live streaming delay based on a difference between the current timestamp and the timestamp of the live streaming bitstream.

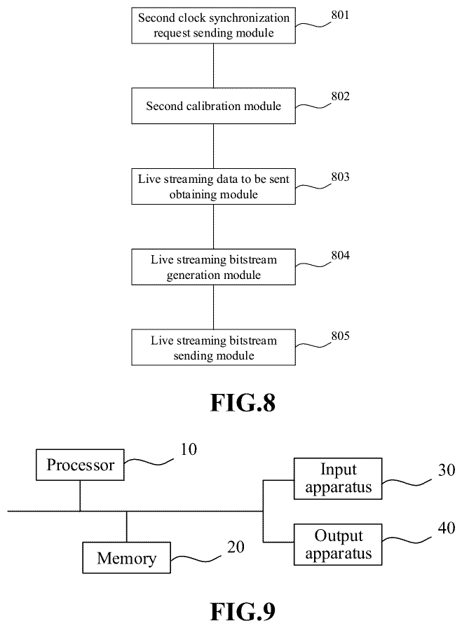

This embodiment provides an apparatus for determining a live streaming delay, as shown in FIG. 8, including:
a second clock synchronization request sending module 801, configured to send a second clock synchronization request to a second server end node to obtain a second calibrated time difference, where the second server end node is used to process live streaming data;
a second calibration module 802, configured to calibrate local time based on the second calibrated time difference to obtain calibrated time;
a live streaming data to be sent obtaining module 803, configured to obtain live streaming data to be sent, and a timestamp corresponding to the live streaming data to be sent;
a live streaming bitstream generation module 804, configured to generate a live streaming bitstream based on the timestamp corresponding to the live streaming data to be sent, as well as the live streaming data to be sent; and
a live streaming bitstream sending module 805, configured to send the live streaming bitstream to the second server end node to reach a peer end, such that when a live streaming delay is determined at the peer end, the second server end node is used to transmit the live streaming bitstream to a first server end node, the first server end node is used to transmit the live streaming bitstream to the peer end, the second server end node and the first server end node are clock-synchronized, and the peer end is used to determine the live streaming delay based on time synchronized with the first server end node and the timestamp in the live streaming bitstream.

In some optional implementations, the live streaming bitstream generation module 804 includes:
an SEI frame determination unit, configured to determine a supplemental enhancement information frame in the live streaming data to be sent; and
a timestamp write unit, configured to write a timestamp corresponding to the live streaming data to be sent into the supplemental enhancement information frame to generate the live streaming bitstream.

The apparatus for determining the live streaming delay in this embodiment is presented in the form of a functional unit. The unit refers to an application specific integrated circuit (ASIC), a processor and a memory executing one or more software or fixed programs, and/or other devices that may provide the above functions.

Further functional descriptions of the above various modules and units are the same as those in the above corresponding embodiments, which are not repeated herein.

An embodiment of the present disclosure further provides a computer device, having the apparatus for determining the live streaming delay shown in FIG. 7 or FIG. 8.

Referring to FIG. 9, FIG. 9 is a structural schematic diagram of a computer device according to an optional embodiment of the present disclosure. As shown in FIG. 9, the computer device includes: one or more processors 10, a memory 20, as well as interfaces for connecting various components, including a high-speed interface and a low-speed interface. The various components are in mutual communication connection using different buses and may be installed on a common motherboard or installed in other methods as needed. The processor may process instructions executed within the computer device, including instructions stored in the memory or on the memory to display graphic information of a graphical user interface (GUI) on an external input/output apparatus (e.g., a display device coupled to the interface). In some optional implementations, a plurality of processors and/or a plurality of buses may be used together with a plurality of memories as needed. Similarly, a plurality of computer devices may be connected. Each device provides some necessary operations (e.g., as a server array, a set of blade servers, or a multiprocessor system). One processor 10 is used as an example in FIG. 9.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field-programmable gate array, a generic array logic, or any combination thereof.

The memory 20 stores instructions executable by at least one processor 10, such that the at least one processor 10 performs the method shown in the above embodiments.

The memory 20 may include a program storage area and a data storage area. The program storage area may store an operating system and an application required by at least one function. The data storage area may store data created based on the use of the computer device. In addition, the memory 20 may include a high-speed random access memory, and may also include a non-transitory memory, such as at least one disk storage device, a flash memory device, or other non-transitory solid-state storage devices. In some optional implementations, the memory 20 optionally includes memories remotely set relative to the processor 10. These remote memories may be connected to the computer device through a network. The examples of the above network include, but are not limited to, an Internet, an intranet, a local area network, a mobile communication network, and a combination thereof.

The memory 20 may include a volatile memory, such as a random access memory. The memory may also include a non-volatile memory, such as a flash memory, a hard drive, or a solid-state drive. The memory 20 may further include combinations of the above types of memories.

The computer device further includes an input apparatus 30 and an output apparatus 40. The processor 10, the memory 20, the input apparatus 30, and the output apparatus 40 may be connected through a bus or other methods, and bus connection is taken as an example in FIG. 9.

The input apparatus 30 may receive input digital or character information and generate key signal inputs relevant to user settings and function control of the computer device, such as a touch screen, a keypad, a mouse, a trackpad, a touchpad, an indicator rod, one or more mouse buttons, a trackball, and a joystick. The output apparatus 40 may include a display device, an auxiliary lighting apparatus (e.g., an LED), a tactile feedback apparatus (e.g., a vibration motor), etc. The display device includes, but is not limited to, a liquid crystal display, a light emitting diode, a display, and a plasma display. In some optional implementations, the display device may be a touch screen.

An embodiment of the present disclosure further provides a computer-readable storage medium. The method according to the embodiments of the present disclosure may be implemented in hardware and firmware, or be implemented as computer code that can be recorded on a storage medium, or is downloaded through the network and originally stored on a remote storage medium or a non-transitory machine-readable storage medium and then is stored on a local storage medium, and therefore the method described herein may be processed by software that is stored on a storage medium using a general-purpose computer, a dedicated processor, or programmable or specialized hardware. The storage medium may be a magnetic disk, an optical disk, a read-only memory, a random access memory, a flash memory, a hard drive, a solid-state drive, or the like. Further, the storage medium may also include combinations of the above types of memories. It should be understood that a computer, a processor, a microprocessor controller, or programmable hardware includes a storage component that can store or receive software or computer code. When the software or the computer code is accessed and executed by the computer, the processor, or the hardware, the method shown in the above embodiments is implemented.

It should be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with relevant laws and regulations may also be applied to the implementations of the present disclosure.

Although the embodiments of the present disclosure are described in conjunction with the accompanying drawings, those skilled in the art may make various modifications and variations without departing from the spirit and scope of the present disclosure, and such modifications and variations fall within the scope defined by the appended claims.

What is claimed is:

1. A method for determining a live streaming delay, comprising:
sending a first clock synchronization request to a first server end node to obtain a first calibrated time difference, wherein the first server end node is used to process live streaming data;
calibrating local time based on the first calibrated time difference to obtain calibrated time;
obtaining a live streaming bitstream generated by a peer end from the first server end node to obtain a timestamp of the live streaming bitstream and a local current timestamp, wherein the timestamp is determined after clock synchronization is performed between the peer end and a second server end node, the second server end node and the first server end node are clock-synchronized, and the live streaming bitstream is transmitted from the second server end node to the first server end node; and
determining a live streaming delay based on the local current timestamp and the timestamp of the live streaming bitstream.

2. The method according to claim 1, wherein sending a first clock synchronization request to a first server end node to obtain a first calibrated time difference comprises:
sending a first clock synchronization request to the first server end node, wherein the first clock synchronization request comprises a first timestamp for sending the first clock synchronization request;
receiving a response message fed back by the first server end node, and determining a fourth timestamp for receiving the response message, wherein the response message carries a second timestamp when the first clock synchronization request arrives the first server end node and a third timestamp when the first server end node sends the response message; and
determining the first calibrated time difference based on the first timestamp, the second timestamp, the third timestamp, and the fourth timestamp.

3. The method according to claim 2, wherein sending a first clock synchronization request to the first server end node comprises:
obtaining a start instruction for a live streaming application to start the live streaming application; and
triggering local sending of the first clock synchronization request to the first server end node after the live streaming application is started.

4. The method according to claim 1, wherein obtaining a live streaming bitstream generated by a peer end from the first server end node to obtain a timestamp of the live streaming bitstream and a local current timestamp comprises:
obtaining a live streaming bitstream generated by a peer end from the first server end node, and determining the local current timestamp;
parsing the live streaming bitstream to determine a supplemental enhancement information frame in the live streaming bitstream; and
extracting a timestamp of the live streaming bitstream from the supplemental enhancement information frame.

5. The method according to claim 1, wherein calibrating local time based on the first calibrated time difference to obtain calibrated time comprises:
determining a sum of the first calibrated time difference and the local time as the calibrated time.

6. The method according to claim 1, wherein determining a live streaming delay based on the local current timestamp and the timestamp of the live streaming bitstream comprises:
determining the live streaming delay based on a difference between the local current timestamp and the timestamp of the live streaming bitstream.

7. A method for determining a live streaming delay, comprising:
sending a second clock synchronization request to a second server end node to obtain a second calibrated time difference, wherein the second server end node is used to process live streaming data;
calibrating local time based on the second calibrated time difference to obtain calibrated time;
obtaining live streaming data to be sent, and a timestamp corresponding to the live streaming data to be sent;
generating a live streaming bitstream based on the timestamp corresponding to the live streaming data to be sent and the live streaming data to be sent; and
sending the live streaming bitstream to the second server end node to arrive a peer end, to determine the live streaming delay at the peer end, wherein the second server end node is used to transmit the live streaming bitstream to a first server end node, the first server end node is used to transmit the live streaming bitstream to the peer end, the second server end node and the first server end node are clock-synchronized, and the peer end is used to determine the live streaming delay based on time synchronized with the first server end node and the timestamp in the live streaming bitstream.

8. The method according to claim 7, wherein generating a live streaming bitstream based on the timestamp corresponding to the live streaming data to be sent and the live streaming data to be sent comprises:
determining a supplemental enhancement information frame in the live streaming data to be sent; and
writing a timestamp corresponding to the live streaming data to be sent into the supplemental enhancement information frame to generate the live streaming bitstream.

9. A computer device, comprising:
a memory and a processor, wherein the memory and the processor are in mutual communication connection, the memory stores computer instructions, and the computer instructions, when executed by the processor, cause the computer device to:
send a first clock synchronization request to a first server end node to obtain a first calibrated time difference, wherein the first server end node is used to process live streaming data;
calibrate local time based on the first calibrated time difference to obtain calibrated time;
obtain a live streaming bitstream generated by a peer end from the first server end node to obtain a timestamp of the live streaming bitstream and a local current timestamp, wherein the timestamp is determined after clock synchronization is performed between the peer end and a second server end node, the second server end node and the first server end node are clock-synchronized, and the live streaming bitstream is transmitted from the second server end node to the first server end node; and
determine a live streaming delay based on the local current timestamp and the timestamp of the live streaming bitstream.

10. The computer device according to claim 9, wherein the computer instructions causing the computer device to send a first clock synchronization request to a first server end node to obtain a first calibrated time difference further cause the computer device to:
send a first clock synchronization request to the first server end node, wherein the first clock synchronization request comprises a first timestamp for sending the first clock synchronization request;
receive a response message fed back by the first server end node, and determine a fourth timestamp for receiving the response message, wherein the response message carries a second timestamp when the first clock synchronization request arrives the first server end node and a third timestamp when the first server end node sends the response message; and
determine the first calibrated time difference based on the first timestamp, the second timestamp, the third timestamp, and the fourth timestamp.

11. The computer device according to claim 10, wherein the computer instructions causing the computer device to send a first clock synchronization request to the first server end node further cause the computer device to:
obtain a start instruction for a live streaming application to start the live streaming application; and
trigger local sending of the first clock synchronization request to the first server end node after the live streaming application is started.

12. The computer device according to claim 9, wherein the computer instructions causing the computer device to obtain a live streaming bitstream generated by a peer end from the first server end node to obtain a timestamp of the live streaming bitstream and a local current timestamp further cause the computer device to:
obtain a live streaming bitstream generated by a peer end from the first server end node, and determine the local current timestamp;
parse the live streaming bitstream to determine a supplemental enhancement information frame in the live streaming bitstream; and
extract a timestamp of the live streaming bitstream from the supplemental enhancement information frame.

13. The computer device according to claim 9, wherein the computer instructions causing the computer device to calibrate local time based on the first calibrated time difference to obtain calibrated time further cause the computer device to:
determine a sum of the first calibrated time difference and the local time as the calibrated time.

14. The computer device according to claim 9, wherein the computer instructions causing the computer device to determine a live streaming delay based on the local current timestamp and the timestamp of the live streaming bitstream further cause the computer device to:
determine the live streaming delay based on a difference between the local current timestamp and the timestamp of the live streaming bitstream.
